(19) United States
(12) Patent Application Publication
(10) Pub. No.: US 2025/0177973 A1
(43) Pub. Date: Jun. 5, 2025

(54) SAMPLE TUBE CONNECTORS AND METHODS FOR ATTACHING A MICROFLUIDICS DEVICE TO A SAMPLE TUBE

(71) Applicant: Redbud Labs, Inc., Research Triangle Park, NC (US)

(72) Inventors: Brittany Mason, Research Triangle Park, NC (US); Darrin Swanson, Research Triangle Park, NC (US); Richard Chasen Spero, Research Triangle Park, NC (US)

(73) Assignee: Redbud Labs, Inc., Research Triangle Park, NC (US)

(21) Appl. No.: 18/840,746

(22) PCT Filed: Feb. 24, 2023
(86) PCT No.: PCT/US2023/013805

§ 371 Date: Aug. 22, 2024

Related U.S. Application Data
(60) Provisional application No. 63/313,807, filed on Feb. 25, 2022.

(51) Int. Cl. B01L 3/00

(52) U.S. Cl. CPC B01L 3/502715; B01L 2200/027; B01L 2200/0689; B01L 2400/0478

(57) ABSTRACT

Described herein are sample tube connectors, digital microfluidics (“DMF”) systems, and methods of using the same. The sample tube connectors of the present disclosure are configured to configured to fluidly couple a sample tube having one or more shapes to a microfluidics device fluid enabling transfer from a microfluidics device to a sample tube without the use of additional tools such as pipets.

### CROSS-REFERENCE

This application claims the benefit of U.S. Provisional Application No. 63/313,807, filed Feb. 25, 2022, which is hereby incorporated by reference in its entirety herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

### Field of the Invention

The presently disclosed subject matter relates generally to the processing of biological materials and more particularly to sample tube connectors and methods for attaching a microfluidics device to a standard sample tube.

### State of the Art

In life sciences, sample tubes are commonly used for all kinds of assays, including nucleic acid testing, protein testing, cellular assays, and basic chemistry. Sample tubes may be colloquially referred to as sample tubes, microfuge tubes, polymerase chain reaction (PCR) tubes, or Eppendorf tubes. Sample tubes are readily available in singlets or strips, with or without attached lids, barcoded, or with physical features that eliminate the possibility of confusing which tube holds what sample by reversing the strip. For example, sample tubes are small-volume tubes (e.g., 0.1-0.5 mL) made of high-quality polypropylene suitable for use in thermal transfer applications, such as PCR. Sample tubes may be used individually or in strips of multiple tubes (e.g., an 8-tube strip). Currently, sample tubes used for processing biological materials are loaded by pipetting.

Additionally, microfluidics systems and devices are frequently used for processing biological materials. Namely, microfluidics systems and devices are used in a variety of applications to manipulate, process, and/or analyze biological materials. In one example, a flow cell or digital microfluidics (DMF) device (or DMF cartridge) is used for performing sample prep operations. Following sample prep, the sample may be transferred from the flow cell or DMF device to one or more sample tubes by manual pipetting. A drawback of loading sample tubes by manual pipetting is that it can be a slow process that does not support automation. Accordingly, there is a need for devices which allow for the adaptation of sample tubes to a microfluidics system to improve sample manipulation.

### SUMMARY

In an aspect, provided herein is a sample tube connector configured to fluidly couple a sample tube to a microfluidics device, the sample tube connector. In some embodiments, the sample tube connector comprises one or more nozzles for hermetically attaching a sample tube having one or more shapes. In some embodiments, the one or more nozzles comprises a flow channel configured to allow a fluid to flow therethrough. In some embodiments, the one or more nozzles comprises a vent channel configured to allow air to escape therethrough.

In some embodiments, the one or more nozzles are made from a rigid material.

In some embodiments, the sample tube connector is formed from a single material.

In some embodiments, the one or more nozzles are made from a non-rigid material.

In some embodiments, the sample tube connector is formed from one or more materials.

In some embodiments, the non-rigid material is elastomer.

In some embodiments, the non-rigid material enables the sample tube connector to hermetically attach the sample tube having one or more shapes.

In some embodiments, the flow channel is positioned substantially off-center within the one or more nozzles to allow a fluid to run down a sidewall of the sample tube.

In some embodiments, the one or more nozzles is substantially conically shaped.

In some embodiments, the one or more nozzles is substantially the shape of a pipette tip.

In some embodiments, the sample tube connector is configured to be attached to one or more components of a microfluidics device.

In some embodiments, the sample tube connector is either welded or compression fit to the microfluidics device.

In some embodiments, the one or more nozzles are configured to have the sample tube having one or more shapes press fit or compression fit thereto.

In some embodiments, the sample tube connector is configured to allow for manipulation of a fluid from a microfluidics device to the sample tube without use of a pipet.

In another aspect, provided herein is a microfluidics devices comprising the sample tube connector described above.

In another aspect, provided herein is a method for attaching a sample tube to a microfluidics device, the method comprising the steps of: providing the sample tube connector described above; attaching the sample tube connector to a component of a microfluidics device; and attaching a sample tube to the sample tube connector.

In another aspect, provided herein is a method of transferring a sample from a microfluidics device to a sample tube, the method comprising the steps of: providing the sample tube connector described above; attaching the sample tube connector to a component of a microfluidics device; attaching a sample tube to the sample tube connector; manipulating a fluid comprising a sample through at least one channel of the microfluidics device to a point of attachment between the component of the microfluidics device and the sample tube connector; and manipulating the fluid from the at least one channel to the sample tube through one or more nozzles of the sample tube connector.

In some embodiments, the sample is transferred from the microfluidics device to the sample tube without use of a pipet.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a block diagram of an example of a microfluidics system including a microfluidics device having one or more of the presently disclosed sample tube connectors for attaching to standard sample tubes;

FIG. 2 and FIG. 3 illustrate a side view and an end view, respectively, of a portion of a microfluidics device and showing a simplified instantiation of the presently disclosed sample tube connectors for attaching to standard sample tubes;

FIG. 4A and FIG. 4B illustrate an isometric view and a plan view, respectively, of an example of a multi-connector strip that may include multiple sample tube connectors according to one configuration of the invention;

FIG. 5A illustrates an isometric view of the multi-connector strip shown in FIG. 4A and FIG. 4B with sample tubes attached;

FIG. 5B illustrates a cross-sectional view of one sample tube connector of the multi-connector strip shown in FIG. 4A and FIG. 4B with a sample tube attached;

FIG. 6A and FIG. 6B illustrate an isometric view and a plan view, respectively, of an example of a multi-connector strip that may include multiple sample tube connectors according to another configuration of the invention;

FIG. 7A illustrates an isometric view of the multi-connector strip shown in FIG. 6A and FIG. 6B with sample tubes attached;

FIG. 7B illustrates a cross-sectional view of one sample tube connector of the multi-connector strip shown in FIG. 6A and FIG. 6B with a sample tube attached;

FIG. 8 and FIG. 9 illustrate cross-sectional views showing an example of a microfluidics device including the presently disclosed sample tube connectors without and with liquid flowing therethrough, respectively;

FIG. 10A and FIG. 10B illustrate a side view and a plan view, respectively, of an example of a multi-connector strip and indicating example dimensions thereof;

FIG. 11A and FIG. 11B illustrate an isometric view and a plan view, respectively, of an example of a multi-connector strip that may include multiple sample tube connectors according to yet another configuration of the invention;

FIG. 12A illustrates an isometric view of the multi-connector strip shown in FIG. 11A and FIG. 11B with sample tubes attached;

FIG. 12B illustrates a cross-sectional view of one sample tube connector of the multi-connector strip shown in FIG. 11A and FIG. 11B with a sample tube attached;

FIG. 13 illustrates an exploded view of an example of a microfluidics system including a microfluidics device with a multi-connector strip having one or more of the presently disclosed sample tube connectors;

FIG. 14A and FIG. 14B illustrate isometric views of an example of a microfluidics device with a multi-connector strip having one or more of the presently disclosed sample tube connectors;

FIG. 15 and FIG. 16 illustrate an isometric view and a cross-sectional view, respectively, of an example of a standalone sample tube connector according to another configuration of the invention;

FIG. 17 illustrates a cross-sectional view of an example of a portion of a microfluidics device including the sample tube connector shown in FIG. 15 and FIG. 16 and showing an example of a compression fit;

FIG. 18A and FIG. 18B illustrate isometric views of an example of a microfluidics device including the single sample tube connector shown in FIG. 15 and FIG. 16;

FIG. 19 illustrates an isometric view of an example of a microfluidics device including multiple of the sample tube connector shown in FIG. 15 and FIG. 16;

FIG. 20 through FIG. 23B illustrate isometric views of an example of a microfluidics system including the multi-connector strip shown in FIG. 6A and FIG. 6B;

FIG. 24 and FIG. 25 illustrate exploded views of the microfluidics system shown in FIG. 20 through FIG. 23B;

FIG. 26 through FIG. 30 illustrate a front, back, side, top, and bottom view, respectively, of the microfluidics system shown in FIG. 20 through FIG. 23B;

FIG. 31A and FIG. 31B illustrate isometric views of the multi-connector strip of the microfluidics system shown in FIG. 20 through FIG. 23B;

FIG. 32A, FIG. 32B, and FIG. 32C illustrate a front, back, and end view, respectively, of the multi-connector strip of the microfluidics system shown in FIG. 20 through FIG. 23B;

FIG. 33A and FIG. 33B illustrate a top and bottom view, respectively, of the multi-connector strip of the microfluidics system shown in FIG. 20 through FIG. 23B;

FIG. 34A, FIG. 34B, and FIG. 34C illustrate cross-sectional views of the multi-connector strip of the microfluidics system shown in FIG. 20 through FIG. 23B; and

FIG. 35 illustrates a flow diagram of an example of a method of using a microfluidics system including a microfluidics device having one or more of the presently disclosed sample tube connectors.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

In some embodiments, the presently disclosed subject matter provides sample tube connectors for and methods of attaching a microfluidics device to a standard sample tube.

In some embodiments, the presently disclosed sample tube connectors and methods provide a means to interface a microfluidics device, such as a flow cell device and/or digital microfluidics (DMF) device (or cartridge), with a standard sample tube.

In some embodiments, the presently disclosed sample tube connectors and methods provide a means of fluidly connecting a microfluidics device, such as a flow cell device and/or DMF device (or cartridge), directly to a standard sample tube.

In some embodiments, a microfluidics system is provided that may include a microfluidics device, such as a flow cell device and/or DMF device (or cartridge), that may further include any arrangements of the presently disclosed sample tube connector for connecting directly to a standard sample tube.

In some embodiments, the presently disclosed sample tube connectors and methods provide a sample prep workflow including a microfluidics device, such as a flow cell device and/or DMF device (or cartridge), supplying a standard sample tube without handling (e.g., pipetting).

In some embodiments, the presently disclosed sample tube connectors and methods provide a nozzle sized to be fitted within a standard sample tube and including a sample flow channel and a vent channel.

In some embodiments, the presently disclosed sample tube connectors and methods provide a nozzle including a sample flow channel and a vent channel and wherein the sample flow channel may be positioned substantially centered within the nozzle.

In some embodiments, the presently disclosed sample tube connectors and methods provide a nozzle including a sample flow channel and a vent channel and wherein the sample flow channel may be positioned substantially off-center within the nozzle.

In some embodiments, the presently disclosed sample tube connectors and methods provide a multi-connector strip that may include multiple sample tube connectors arranged in a line atop a plate that may be mounted to a microfluidics device, such as a flow cell device and/or DMF device (or cartridge).

In some embodiments, the presently disclosed sample tube connectors and methods provide a four-connector strip that may include four sample tube connectors arranged in a line atop a plate that may be mounted to a microfluidics device, such as a flow cell device and/or DMF device (or cartridge).

In some embodiments, the presently disclosed sample tube connectors and methods provide a standalone or individual sample tube connector that may be installed in a microfluidics device, such as a flow cell device and/or DMF device (or cartridge).

In some embodiments, arrangements of the presently disclosed sample tube connector may be provided in a microfluidics device, such as a flow cell device and/or DMF device (or cartridge), that support singleplex and/or multiplex processing.

In some embodiments, the presently disclosed sample tube connectors and methods support the ability to modularize different microfluidics components.

### Microfluidics System

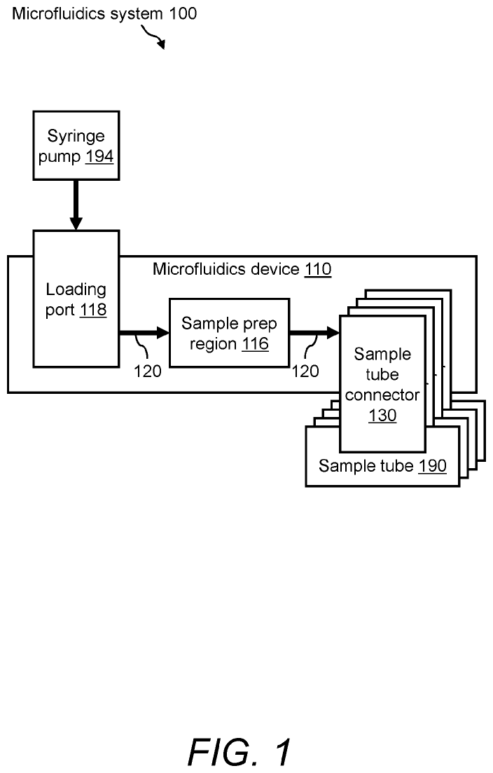

Referring now to FIG. 1 is a block diagram of an example of a microfluidics system 100 including a microfluidics device 110 having one or more of the presently disclosed sample tube connectors for attaching to standard sample tubes. Microfluidics device 110 may be a device for processing biological materials, such as sample prep processes. For example, microfluidics device 110 may be a flow cell device, a DMF device, a DMF cartridge, a droplet actuator, and the like. By way of example, microfluidics device 110 shown in FIG. 1 may be a flow cell device that may include a sample prep region 116. A loading port (or well) 118 may supply sample prep region 116. Sample prep region 116 may supply any arrangement of one or more sample tube connectors 130. Generally, loading port 118, sample prep region 116, and sample tube connectors 130 may be fluidly coupled via a flow channel 120. Sample prep region 116 may be, for example, one or more reaction chambers in which any biological processes may occur with respect to sample prep in advance of PCR, for example.

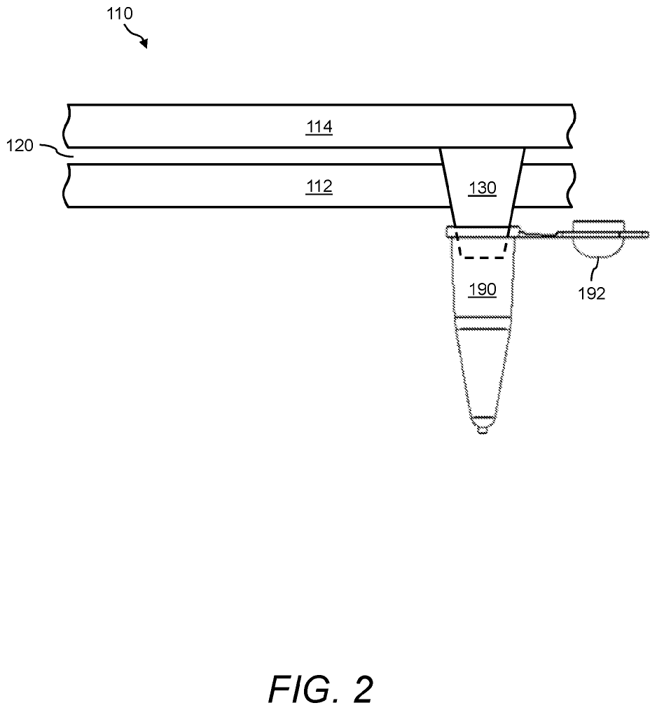

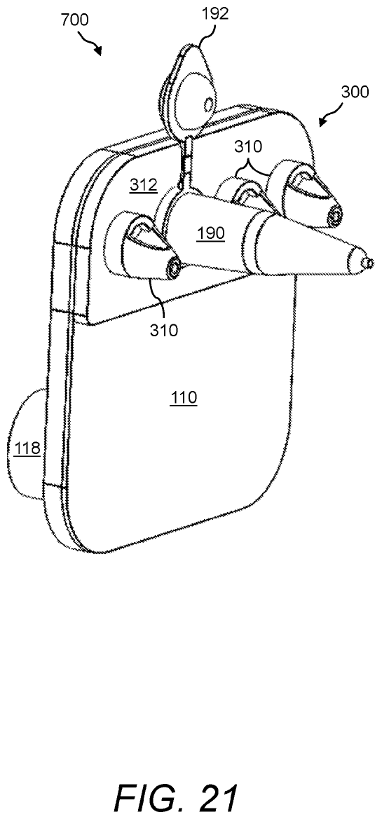

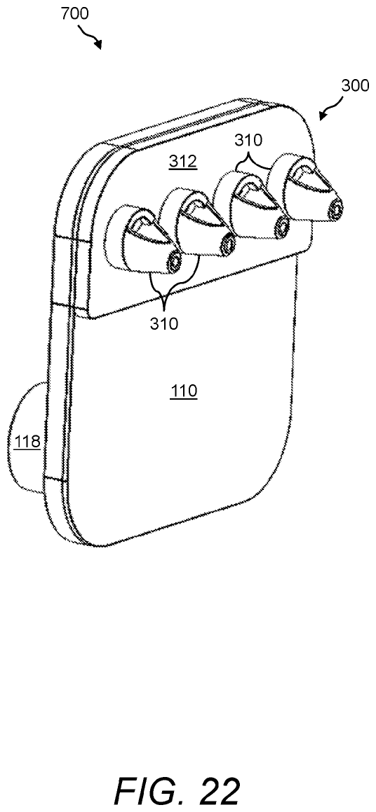

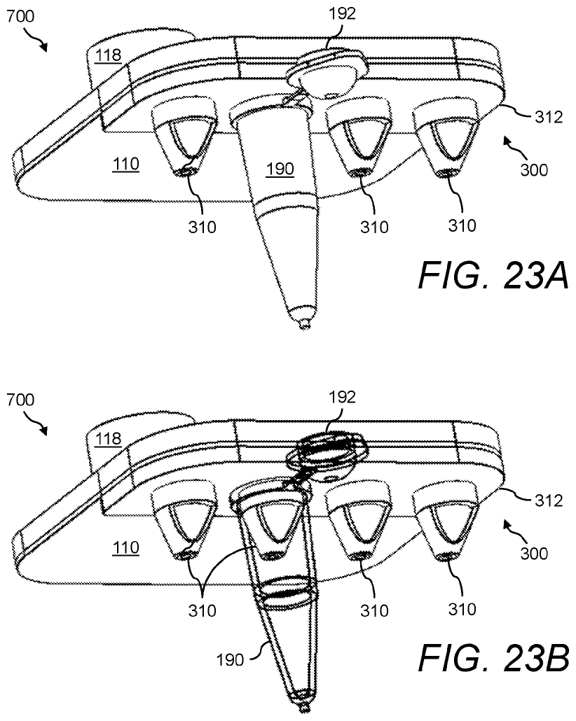

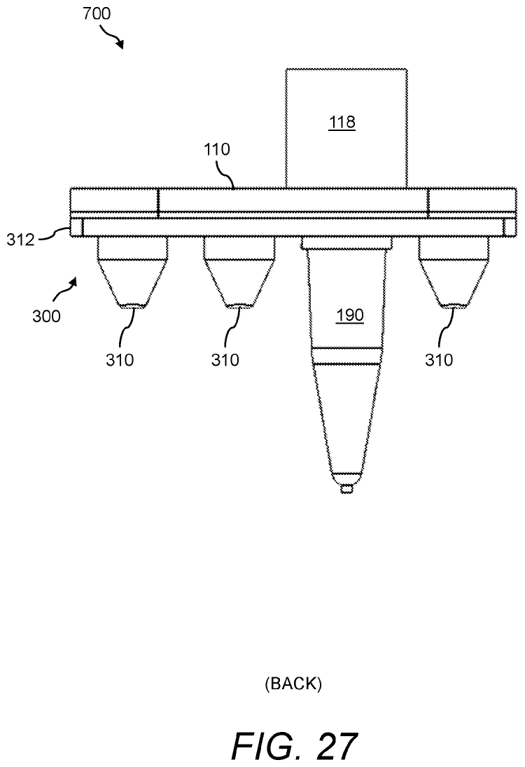

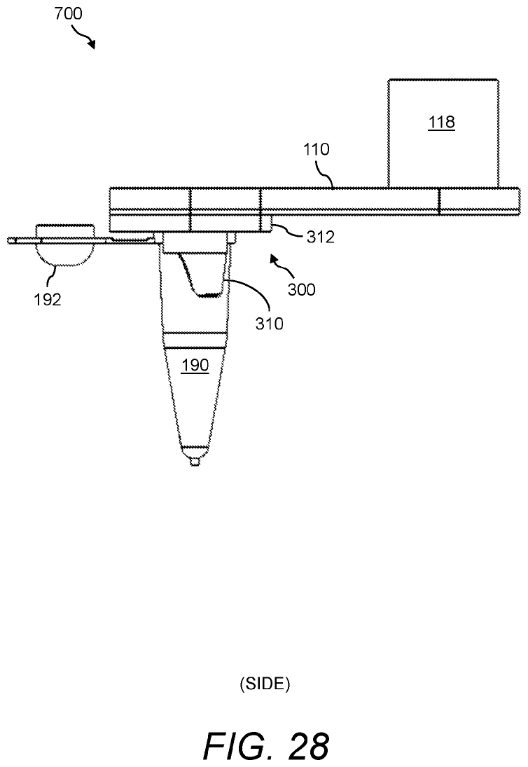

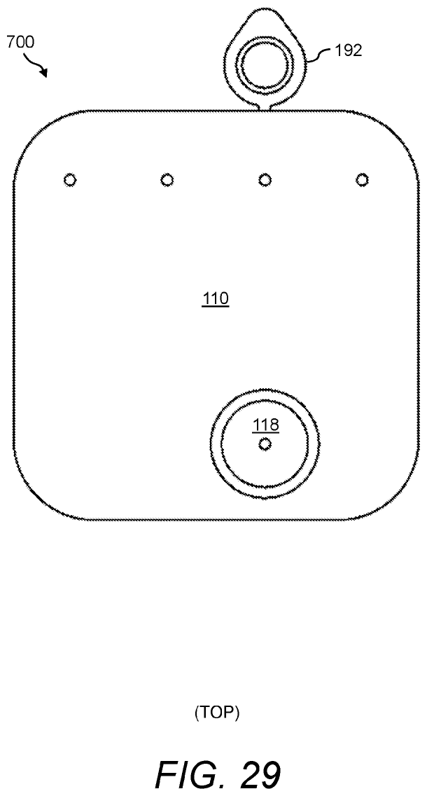

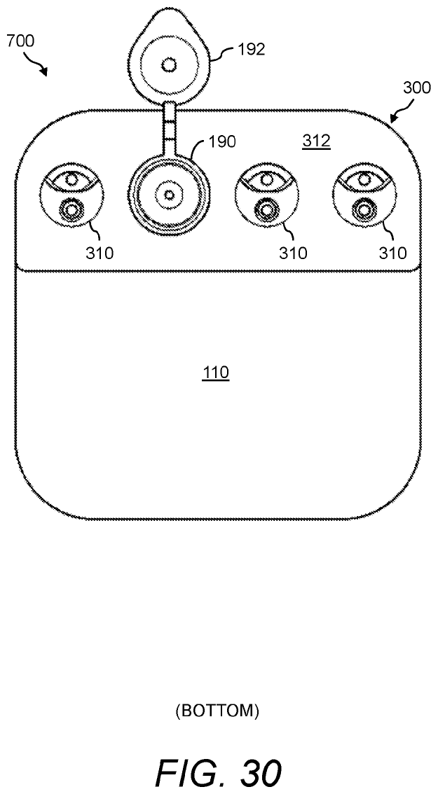

Each of the one or more sample tube connectors 130 may be designed to easily couple to a standard sample tube, such as to a sample tube 190. In one example, a sample tube 190 may be press-fitted onto a nozzle of a corresponding sample tube connector 130. In microfluidics system 100, sample fluid may be processed in microfluidics device 110. Then, using one or more sample tube connectors 130, the processed sample fluid may be dispensed directly from microfluidics device 110 into one or more sample tubes 190. More details of examples of sample tube connectors 130 are shown and described hereinbelow with reference to FIG. 2 through FIG. 35.

In the example of microfluidics device 110 being a flow cell device, pressure may be the means of pushing sample liquid through microfluidics device 110. In one example, a syringe pump 194 may be used to supply the sample liquid to be processed to microfluidics device 110. That is, syringe pump 194 may be mechanically and/or fluidly coupled to loading port 118 and then supply sample liquid under pressure to and through microfluidics device 110. Syringe pump 194 is just one example, other types of pressure devices or other methods may be used to supply sample liquid to microfluidics device 110. For example, any kind of perfusion or droplet actuation method may be used to supply sample liquid to microfluidics device 110.

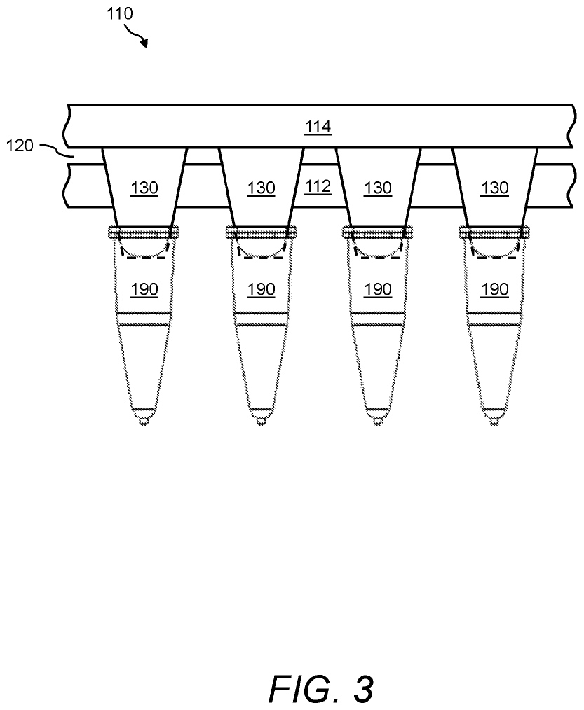

Referring now to FIG. 2 and FIG. 3 is a side view and an end view, respectively, of a portion of a microfluidics device 110 and showing a simplified instantiation of the presently disclosed sample tube connectors 130 for attaching to standard sample tubes 190. In this example, microfluidics device 110 may include a bottom substrate 112 and a top substrate 114 separated by a gap, which may be, for example, flow channel 120. In the example of microfluidics device 110 being a flow cell device, bottom substrate 112 and top substrate 114 may be, for example, glass or plastic substrates. In this simplified illustration, each of the sample tube connectors 130 may provide a tapered-structure or -nozzle that may be used to mechanically and/or fluidly couple to a standard sample tube 190. For example, a sample tube 190 may be press-fitted onto a sample tube connector 130. Additionally, each sample tube 190 may include a flip-cap 192 for opening and closing the sample tube 190.

In this example, flow channel 120 of microfluidics device 110 supplies an inlet (not shown) of each sample tube connector 130. Then, an outlet (not shown) of each sample tube connector 130 supplies the sample tube 190. Once filled, the sample tube 190 may be removed from its corresponding sample tube connector 130 and capped via its flip-cap 192.

### Sample Tube Connectors

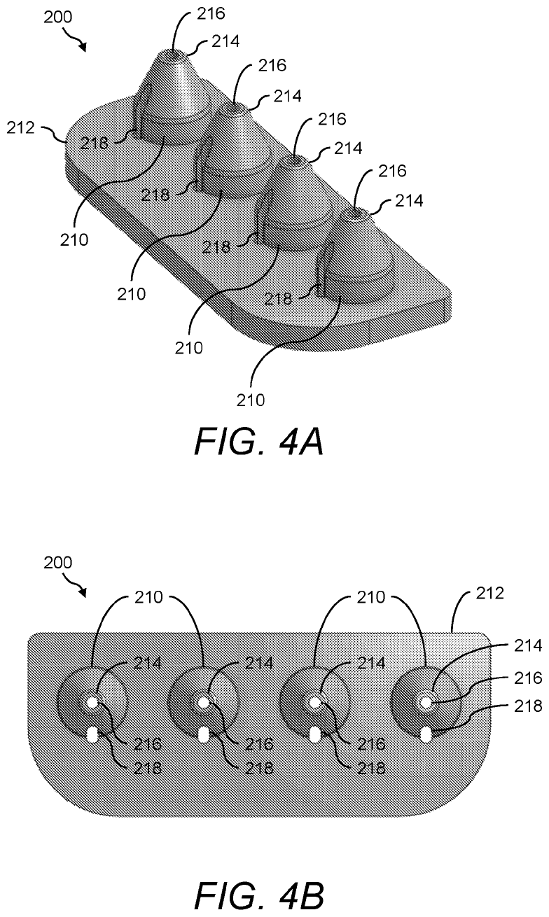

Referring now to FIG. 4A and FIG. 4B is an isometric view and a plan view, respectively, of an example of a multi-connector strip 200 that may include multiple sample tube connectors according to one configuration of the invention. For example, multi-connector strip 200 may include multiple nozzles 210 arranged in a line atop a plate 212. More specifically, four nozzles 210 may be arranged in a line atop plate 212 to provide a four-connector strip 200. Nozzles 210 of multi-connector strip 200 may be an example of sample tube connectors 130 shown in FIG. 1, FIG. 2, and FIG. 3.

Each of the nozzles 210 may be substantially conical-shaped with its small tip 214 facing away from plate 212. Tip 214 of nozzle 210 may be modeled similar to a standard pipette tip. Each of the nozzles 210 may include a flow channel 216 and a vent channel 218 and wherein both the flow channel 216 and vent channel 218 pass through plate 212. In one example, four-connector strip 200 may be formed of thermoplastic materials using a thermoplastic injection molding process.

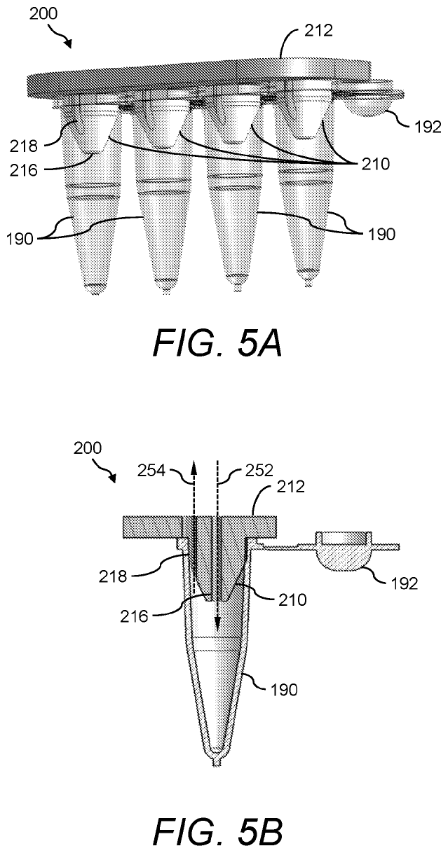

Referring now to FIG. 5A is an isometric view of multi-connector strip 200 shown in FIG. 4A and FIG. 4B with sample tubes 190 attached. Further to the example, FIG. 5B shows a cross-sectional view of one nozzle 210 of multi-connector strip 200 with a sample tube 190 attached.

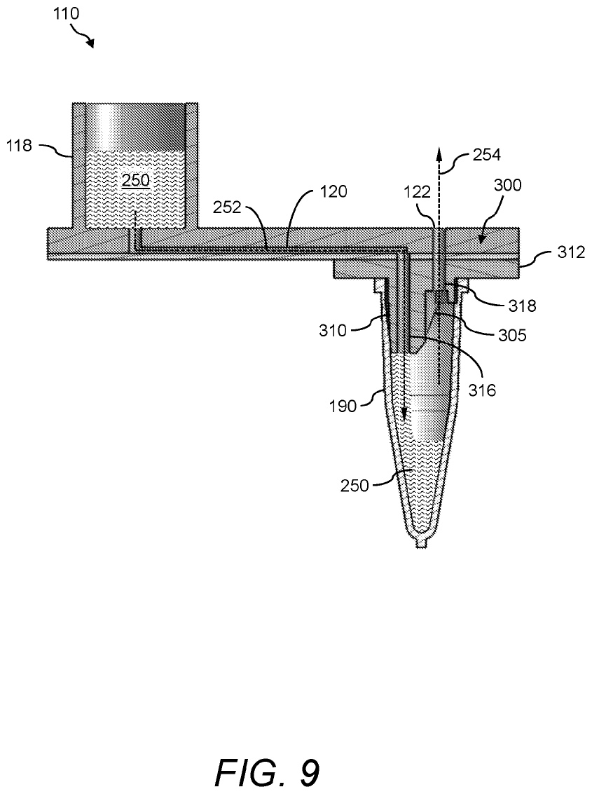

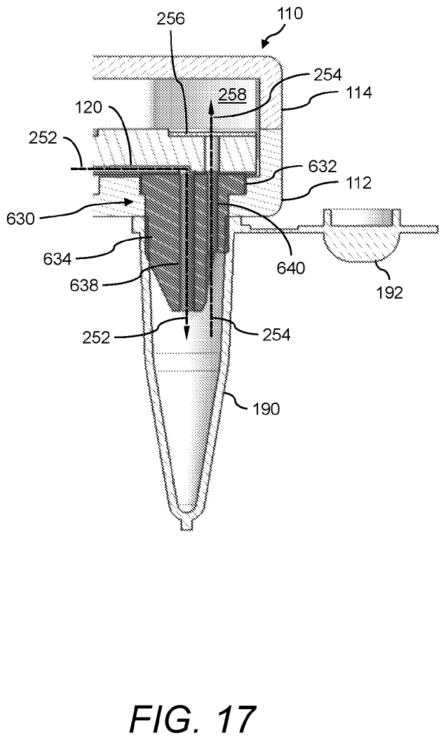

In this example, nozzle 210 substantially mimics the shape of a pipette tip. Flow channel 216 may be arranged at substantially the center of nozzle 210. By contrast, vent channel 218 may be arranged at one side of nozzle 210. Accordingly, FIG. 5B shows a liquid flow 252 may be delivered through flow channel 216 and at substantially the center of sample tube 190 using the pipette-like nozzle 210. In this example, liquid may fall from nozzle 210 through free space into sample tube 190. At the same time, air flow 254 may be provided through vent channel 218 (also see FIG. 9 and FIG. 17). Vent channel 218 may be a port to open air or to an air collection space (see FIG. 17). The purpose of vent channel 218 may be to prevent pressure build up in sample tube 190 as sample liquid is dispensed therein.

In the biological processes of microfluidics system 100 and/or microfluidics device 110, each sample tube 190 may contain some volume (e.g., about 100 μL) of reaction mixture (e.g., PCR master mix) for reacting with purified nucleic acid, which may be the output of the sample prep operations of microfluidics device 110. In one example, using four-connector strip 200, from about 10 μL to about 25 μL of liquid may be dispensed from each nozzle 210 into the sample tube 190.

Referring now again to FIG. 2 through FIG. 5B, sample tubes 190 may be any standard commercially available sample tubes. Sample tubes may be colloquially referred to as sample tubes, microfuge tubes, PCR tubes, or Eppendorf tubes. Sample tubes may be small-volume tubes (e.g., 0.1-0.5 mL) made of high-quality polypropylene suitable for use in thermal transfer applications, such as PCR. Sample tubes may be used individually or in strips of multiple sample tubes (e.g., an 8-tube strip). In the case of sample tube strips, a standard pitch may be, for example, 9 mm on-center for use with multi-well plates. Sample tubes and caps (e.g., sample tubes 190 and flip-caps 192) are compatible with most leading thermal cyclers, and are autoclavable. Caps, available as either flat or domed, fit perfectly and create a uniform, tight seal that prevents sample evaporation in the thermal cycler.

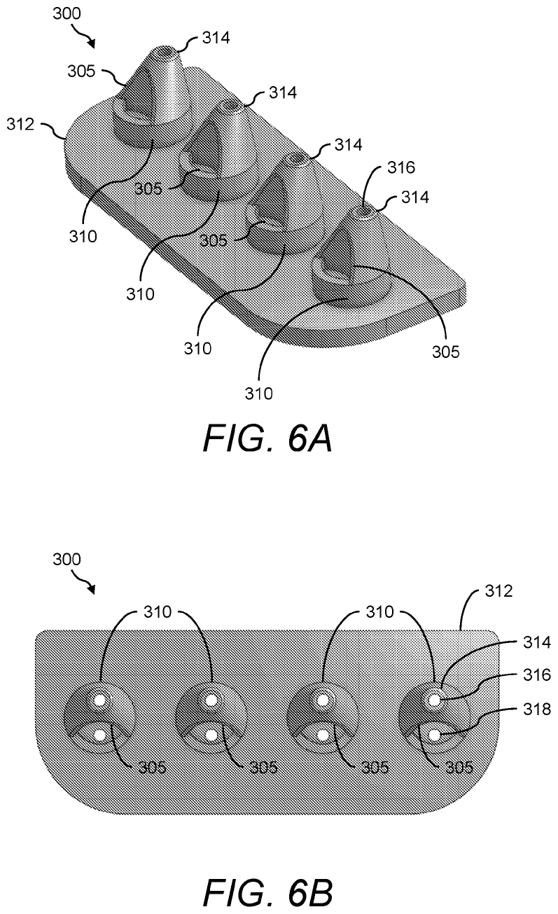

Referring now to FIG. 6A and FIG. 6B is an isometric view and a plan view, respectively, of an example of a multi-connector strip 300 that may include multiple sample tube connectors according to another configuration of the invention. For example, multi-connector strip 300 may include multiple nozzles 310 arranged in a line atop a plate 312. More specifically, four nozzles 310 may be arranged in a line atop plate 312 to provide a four-connector strip 300. Nozzles 310 of multi-connector strip 300 may be another example of sample tube connectors 130 shown in FIG. 1, FIG. 2, and FIG. 3. Each of the nozzles 310 may be substantially conical-shaped with its small tip 314 facing away from plate 312. Tip 314 of nozzle 310 may be modeled similar to a standard pipette tip. Each of the nozzles 310 may include a flow channel 316 and a vent channel 318 and wherein both the flow channel 316 and vent channel 318 pass through plate 312. In one example, four-connector strip 300 may be formed of thermoplastic materials using a thermoplastic injection molding process.

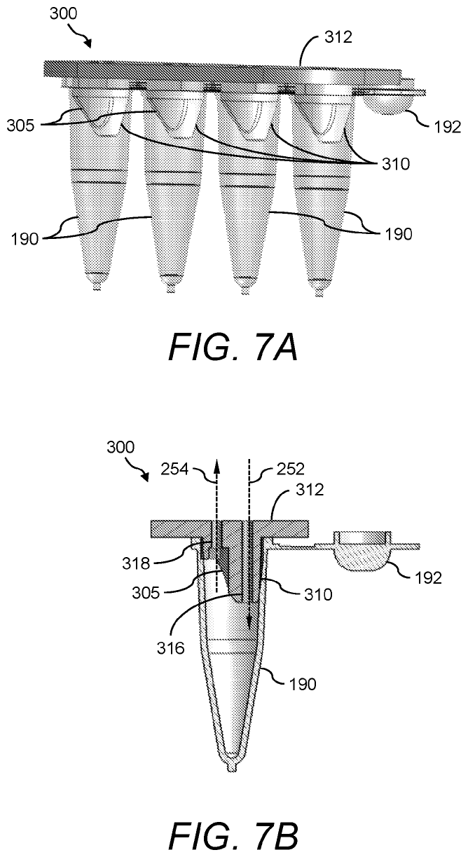

Referring now to FIG. 7A is an isometric view of multi-connector strip 300 shown in FIG. 6A and FIG. 6B with sample tubes 190 attached. Further to the example, FIG. 7B shows a cross-sectional view of one nozzle 310 of multi-connector strip 300 with a sample tube 190 attached.

In this example, nozzle 310 substantially mimics the shape of a pipette tip. However, in this example, tip 314 with its flow channel 316 may be justified to one side of nozzle 310 instead of centered. Further, a cutaway or clearance region 305 leading to vent channel 318 is provided on the side of nozzle 310 away from flow channel 316.

Accordingly, FIG. 7B shows liquid flow 252 may be delivered through flow channel 316 of the pipette-like nozzle 310 and at substantially one side of sample tube 190. This configuration of tip 314 and flow channel 316 allows sample liquid to run down the sidewall of sample tube 190. At the same time, air flow 254 may be provided through vent channel 318 (also see FIG. 9 and FIG. 17). Vent channel 318 may be a port to open air or to an air collection space (see FIG. 17). Again, vent channel 318 may be used to prevent pressure build up in sample tube 190 as sample liquid is dispensed therein.

Again, each sample tube 190 may contain some volume (e.g., about 100 μL) of reaction mixture (e.g., PCR master mix) for reacting with purified nucleic acid, which may be the output of the sample prep operations of microfluidics device 110. In one example, using four-connector strip 300, from about 10 μL to about 25 μL of liquid may be dispensed from each nozzle 310 into the sample tube 190.

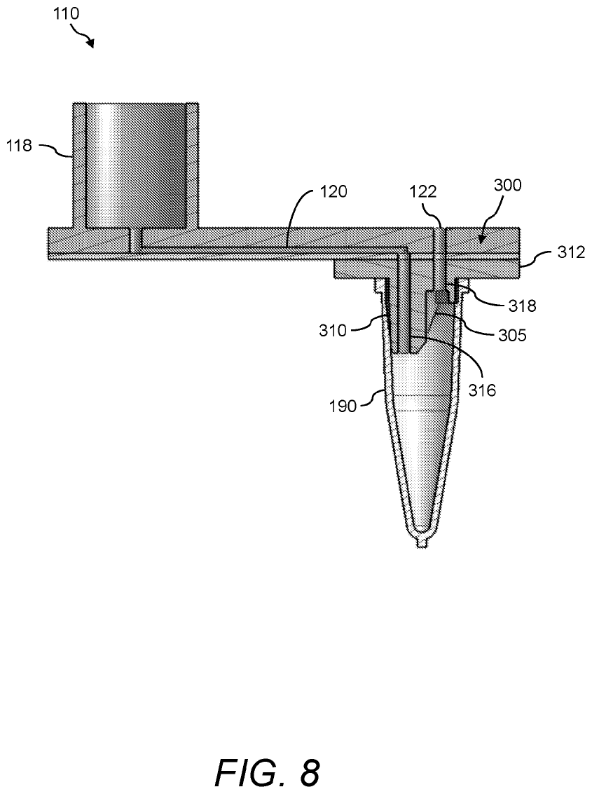

Referring now to FIG. 8 and FIG. 9 is cross-sectional views showing an example of a microfluidics device 110 including the presently disclosed sample tube connectors without and with liquid flowing therethrough, respectively. For example, FIG. 8 shows microfluidics device 110 including multi-connector strip 300 with nozzles 310 as well as loading port 118 that is absent any sample liquid. Accordingly, there is no liquid in flow channel 120 to be delivered to sample tube 190 via a nozzle 310 of multi-connector strip 300. By contrast, FIG. 9 shows loading port 118 of microfluidics device 110 holding a quantity of liquid 250, such as sample liquid. Then, liquid 250 may flow under pressure through flow channel 120 of microfluidics device 110. Then, liquid 250 may flow under pressure through flow channel 316 of nozzle 310 of multi-connector strip 300 and into sample tube 190. More specifically, in this example, nozzle 310 may be used to immediately direct the flow of liquid 250 down the sidewall of sample tube 190 (instead of falling through free space). At the same time, to balance the pressure inside sample tube 190, air flow 254 may escape through vent channel 318 of nozzle 310.

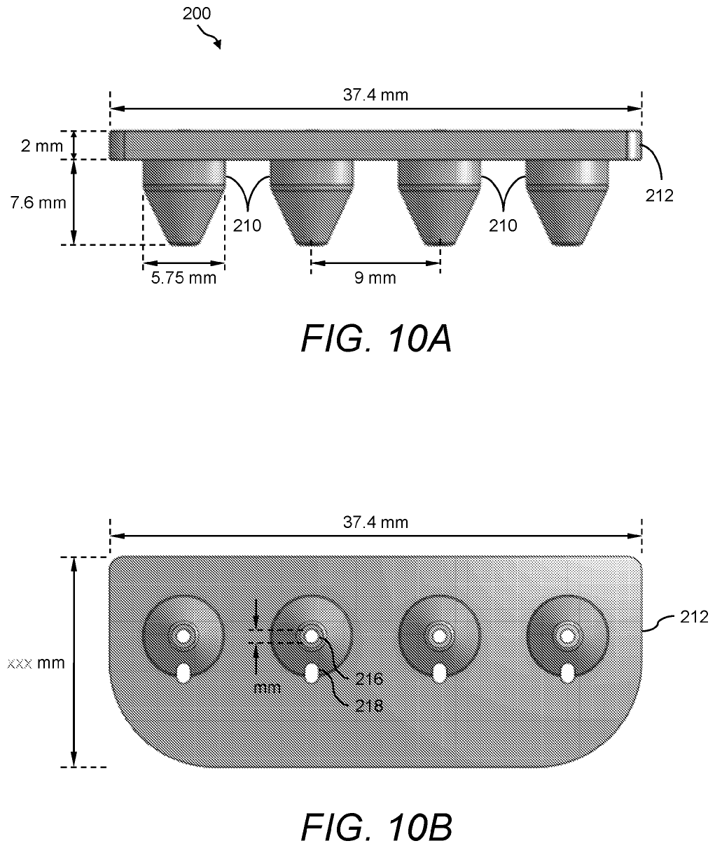

Referring now to FIG. 10A and FIG. 10B is a side view and a plan view, respectively, of an example of a multi-connector strip and indicating example dimensions thereof. For example, FIG. 10A and FIG. 10B show example dimensions of the four-connector strip 200 shown in FIG. 4A through FIG. 5B. However, these example dimensions may also apply to the four-connector strip 300 shown in FIG. 6A through FIG. 7B.

In this example, the overall length of plate 212 may be about 37.4 mm, the width of plate 212 may be about 37 mm, and the thickness of plate 212 may be about 1.5 mm. Further, in this example, the diameter of nozzles 210 may be about 5.75 mm and the height of nozzles 210 may be about 7.6 mm. Further, in this example, the on-center pitch of nozzles 210 may be about 9 mm. Further, in this example, the diameter of flow channel 216 of nozzle 210 may be up to about 1 mm. Again, these dimensions are exemplary only. The dimensions may vary depending on the sample tubes being used.

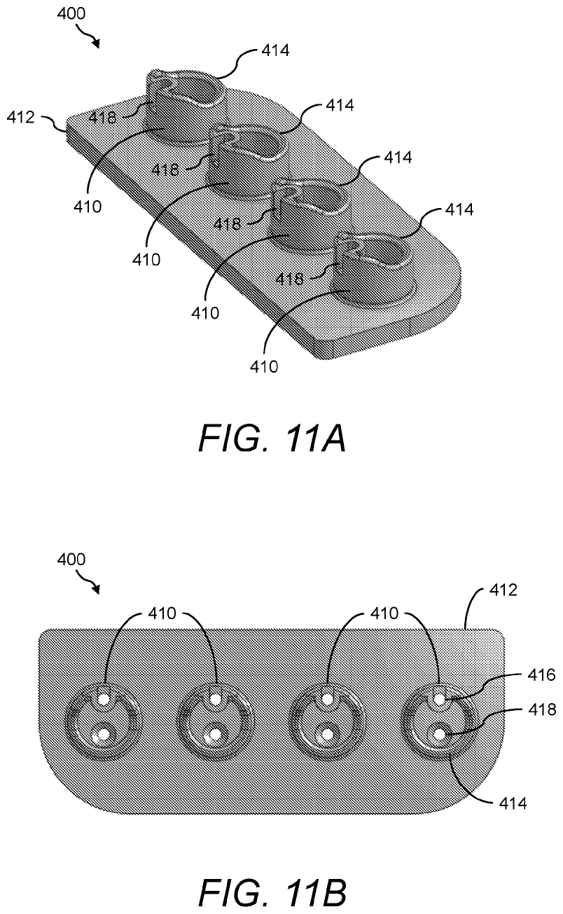

Referring now to FIG. 11A and FIG. 11B is an isometric view and a plan view, respectively, of an example of a multi-connector strip 400 that may include multiple sample tube connectors according to yet another configuration of the invention. For example, multi-connector strip 400 may include multiple nozzles 410 arranged in a line atop a plate 412. More specifically, four nozzles 410 may be arranged in a line atop plate 412 to provide a four-connector strip 400. Nozzles 410 of multi-connector strip 400 may be another example of sample tube connectors 130 shown in FIG. 1, FIG. 2, and FIG. 3. Each of the nozzles 410 may be a substantially open-ended nozzle 410 that has a contoured rim 414 facing away from plate 412. Each of the nozzles 410 may include a flow channel 416 and a vent channel 418 and wherein both the flow channel 416 and vent channel 418 pass through plate 412. In one example, four-connector strip 400 may be formed of thermoplastic materials using a thermoplastic injection molding process.

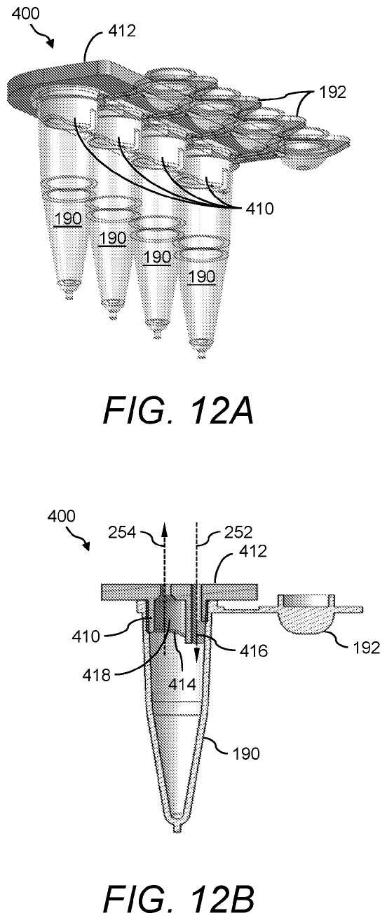

Referring now to FIG. 12A is an isometric view of multi-connector strip 400 shown in FIG. 11A and FIG. 11B with sample tubes 190 attached. Further to the example, FIG. 12B shows a cross-sectional view of one nozzle 410 of multi-connector strip 400 with a sample tube 190 attached.

In this example, flow channel 416 may be justified to one side of nozzle 410, not centered. More specifically, flow channel 416 intentionally opens toward the sidewall of sample tube 190. Further, vent channel 418 is provided on the side of nozzle 410 away from flow channel 416. In this example, the height of contoured rim 414 with respect to plate 412 is greater at the region of flow channel 416 than at the region of vent channel 418. However, in other embodiments, rim 414 may not be contoured, but instead may be planar all the way across nozzle 410.

Accordingly, FIG. 12B shows liquid flow 252 may be delivered through flow channel 416 of the nozzle 410. Because flow channel 416 intentionally opens toward the sidewall of sample tube 190, liquid may intentionally flow down the sidewall of sample tube 190. More specifically, in this example, nozzle 410 may be used to immediately direct the flow of liquid 250 down the sidewall of sample tube 190 (instead of falling through free space). At the same time, air flow 254 may be provided through vent channel 418 (also see FIG. 9 and FIG. 17). Vent channel 418 may be a port to open air or to an air collection space (see FIG. 17). Again, vent channel 418 may be used to prevent pressure build up in sample tube 190 as sample liquid is dispensed therein.

Again, each sample tube 190 may contain some volume (e.g., about 100 μL) of reaction mixture (e.g., PCR master mix) for reacting with purified nucleic acid, which may be the output of the sample prep operations of microfluidics device 110. In one example, using four-connector strip 400, from about 10 μL to about 25 μL of liquid may be dispensed from each nozzle 410 into the sample tube 190.

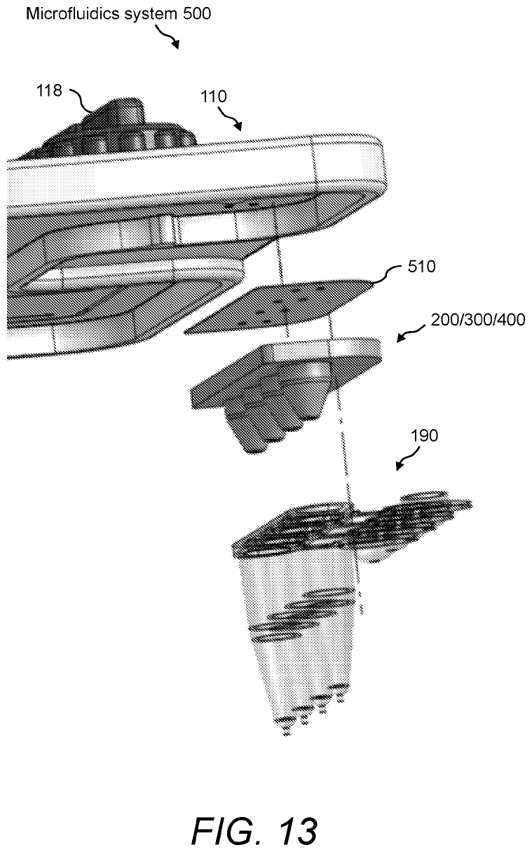

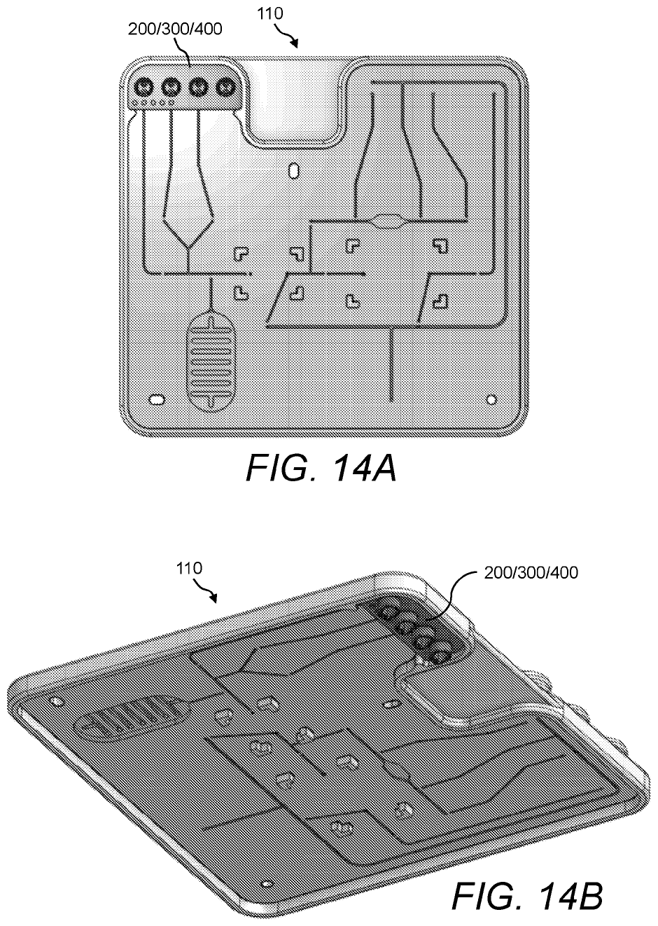

Referring now to FIG. 13 is an exploded view of an example of a microfluidics system 500 including microfluidics device 110 with a multi-connector strip having one or more of the presently disclosed sample tube connectors. Microfluidics system 500 may be an example of the microfluidics system 100 shown in FIG. 1. For example, microfluidics system 500 may include microfluidics device 110 and four-connector strip 200 shown in FIG. 4A through FIG. 5B, or four-connector strip 300 shown in FIG. 6A through FIG. 7B, or four-connector strip 400 shown in FIG. 11A through FIG. 12B. Further, FIG. 14A and FIG. 14B shows isometric views of an example of microfluidics device 110 of microfluidics system 500 shown in FIG. 13 with the four-connector strip 200, 300, or 400 coupled thereto.

Various methods are possible for coupling four-connector strip 200, 300, or 400 to the substrate of microfluidics device 110. In one example, a coupling layer 510 may be provided between the substrate of microfluidics device 110 and four-connector strip 200, 300, or 400. Coupling layer 510 may be, for example, a pressure sensitive adhesive (PSA) layer, an elastomer layer, and the like. In another example, four-connector strip 200, 300, or 400 may be coupled to the substrate of microfluidics device 110 using laser welding and/or ultrasonic welding from the microfluidics device 110-side. When welded, it may be beneficial that the welding be around the outer periphery four-connector strip 200, 300, or 400 and also around each nozzle thereof. In yet another example, one or more connectors may be installed into microfluidics device 110 via compression mechanisms. An example of a compression fit is shown and described hereinbelow with reference to FIG. 17.

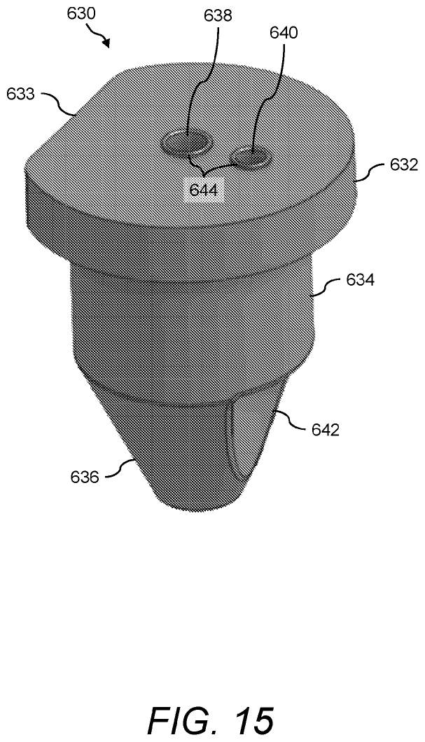

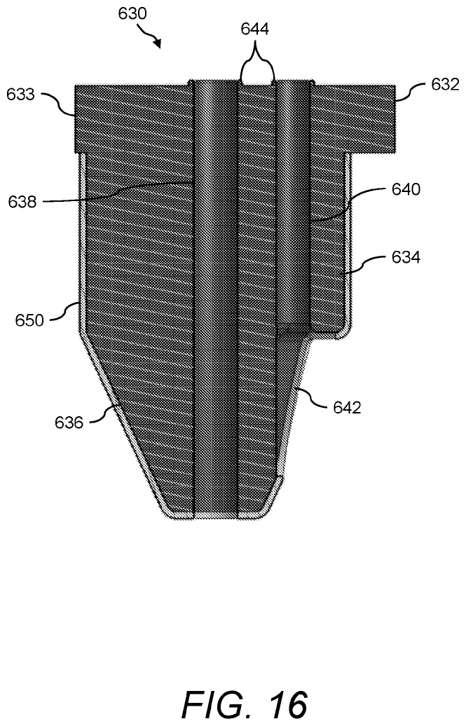

Referring now to FIG. 15 and FIG. 16 is an isometric view and a cross-sectional view, respectively, of an example of a standalone sample tube connector 630 according to another configuration of the invention. In this example, sample tube connector 630 may include a top plate 632 that has a flat or key 633, a nozzle body 634, and a tapered nozzle tip 636. Sample tube connector 630 may also include a flow channel 638 and a vent channel 640 and wherein both the flow channel 638 and vent channel 640 pass through top plate 632. Leading to vent channel 640, a cutaway or clearance region 642 may be provided in nozzle tip 636. Optionally, O-rings (or gaskets) 644 may be provided atop top plate 632 and at the openings of flow channel 638 and vent channel 640.

Various materials and fabrication processes may be used to form sample tube connector 630. In one example, sample tube connector 630 may be formed of rigid materials, such as thermoplastic materials. In another example, sample tube connector 630 may be formed of non-rigid materials, such as elastomer materials. In yet another example, sample tube connector 630 may be formed of a combination of both rigid and non-rigid materials, as shown, for example, in FIG. 16.

With respect to rigid materials, sample tube connector 630 may be formed, for example, of polycarbonate via a thermoplastic injection molding process. This process lends well to welding. With respect to non-rigid materials, sample tube connector 630 may be formed, for example, of thermoplastic elastomer (TPE) via a thermoplastic injection molding process or liquid silicone rubber (LSR) via a liquid injection molding process. Further, sample tube connector 630 may be provided separate from microfluidics device 110 or may be molded directly onto microfluidics device 110.

With respect both rigid and non-rigid materials, FIG. 16 shows an example of sample tube connector 630 that may be formed of rigid material, such as thermoplastic, that has a non-rigid overmold layer 650 that may be formed, for example, of elastomer material (e.g., TPE). The presence of the non-rigid overmold layer 650 may allow a more universal fit with various sample tubes. The non-rigid overmold layer 650 may provide a spring effect. In one example, non-rigid overmold layer 650 may be from about 0.5 mm to about 1.5 mm thick.

The design of the standalone sample tube connector 630 may provide certain advantages, such as, but not limited to (1) lends well to a compression fit assembly (see FIG. 17), (2) easy to manufacture, and (3) enables a universal fit with sample tubes. FIG. 17 shows an example of the operation of sample tube connector 630.

Referring now to FIG. 17 is a cross-sectional view of an example of a portion of microfluidics device 110 including sample tube connector 630 shown in FIG. 15 and FIG. 16 and showing an example of a compression fit. In this example, sample tube connector 630 is fitted between bottom substrate 112 and top substrate 114 and wherein bottom substrate 112 and top substrate 114 may be compressed together and sealed around and against sample tube connector 630. O-rings (or gaskets) 644 may be used to seal the openings of flow channel 638 and vent channel 640 within microfluidics device 110. For example, bottom substrate 112 and top substrate 114 of microfluidics device 110 may be a shell design that can be squeezed together around sample tube connector 630. In another example, sample tube connector 630 and microfluidics device 110 may provide a snap-in design to provide a compression fit of sample tube connector 630 and microfluidics device 110.

In this example, sample tube connector 630 may be used to direct liquid flow 252 through flow channel 638 at substantially the center of sample tube 190. At the same time, to balance the pressure inside sample tube 190, air flow 254 may escape through vent channel 640 of sample tube connector 630. Further, in this example, air flow 254 escaping through vent channel 640 may pass through, for example, a membrane 256 to a collection space 258 of microfluidics device 110. In one example, membrane 256 may be formed of a hydrophobic venting material that may serve as a one-way check valve into collection space 258. Collection space 258 may be provided to avoid expelling contaminated air into the open environment.

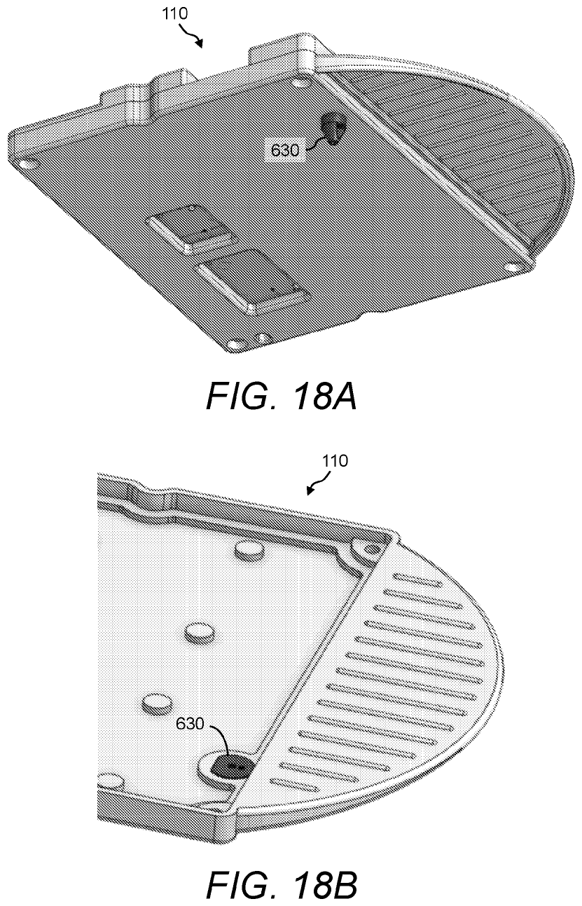

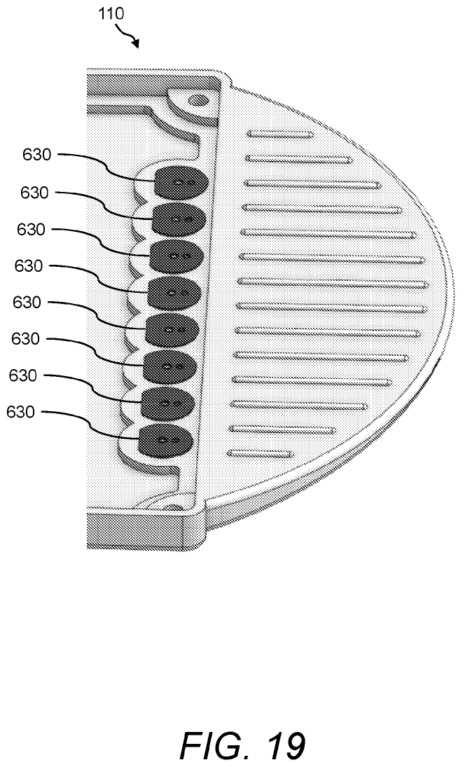

Configurations of the presently disclosed sample tube connectors may be provided to support both singleplex and multiplex operations. For example, FIG. 18A and FIG. 18B shows isometric views of an example of a microfluidics device 110 including a single sample tube connector 630 shown in FIG. 15 and FIG. 16. This is an example of microfluidics device 110 configured for singleplex PCR operations using the one sample tube connector 630. By contrast, FIG. 19 shows an isometric view of an example of a microfluidics device 110 including multiple sample tube connectors 630, such as eight sample tube connectors 630. This is an example of microfluidics device 110 configured for eight-plex operations using the eight sample tube connectors 630. For example, this eight-plex configuration shown in FIG. 19 may couple to an 8-tube strip.

In another example, four-connector strips 200, 300, 400 shown in FIG. 4A through FIG. 14B may be used to support four-plex operations. For example, an 8-tube strip may be cut in half to form two 4-tube strips that may couple to any of the four-connector strips 200, 300, 400.

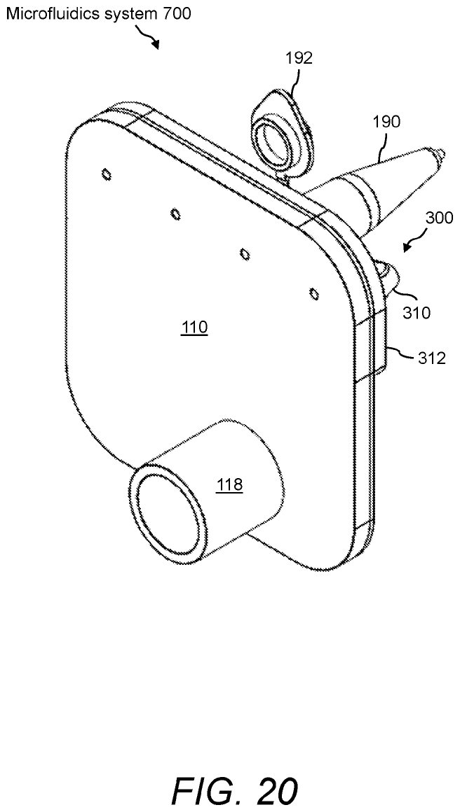

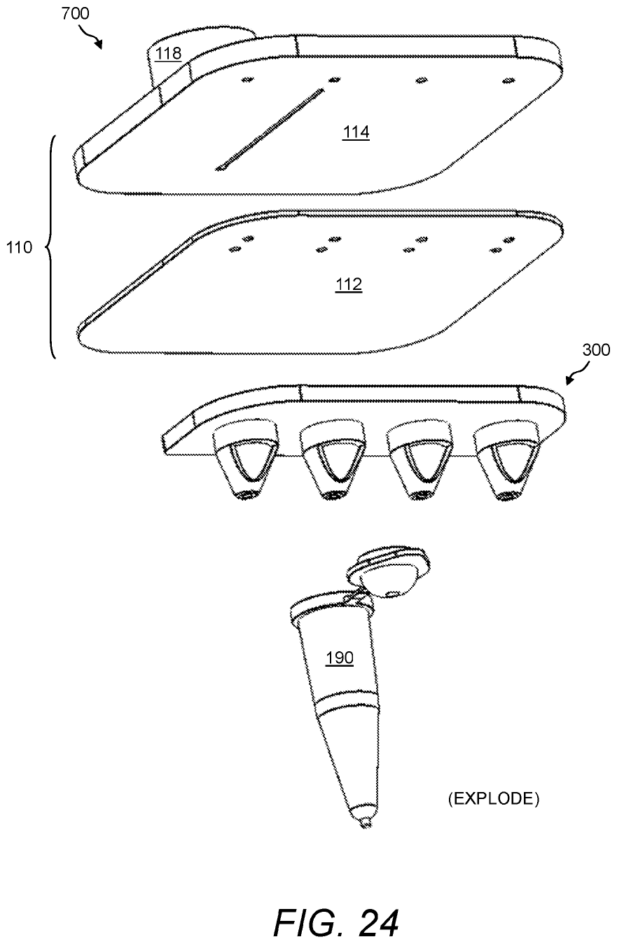

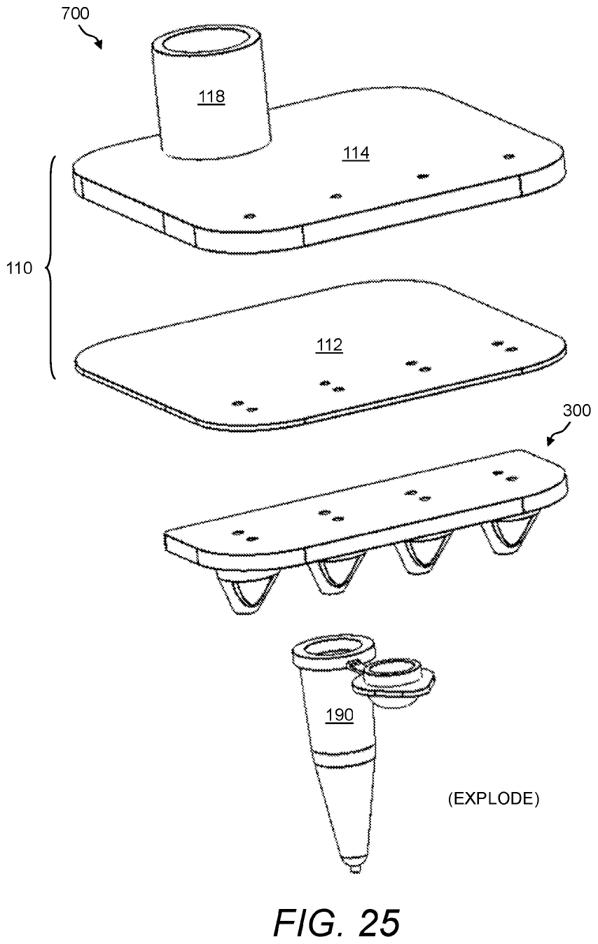

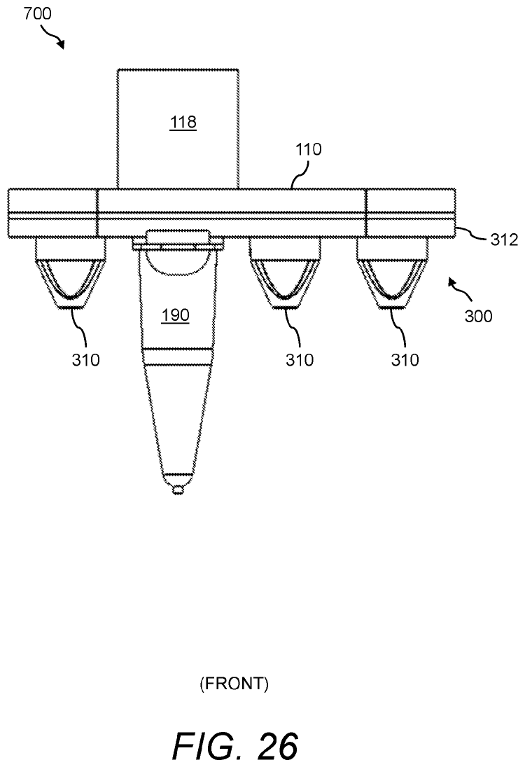

Referring now to FIG. 20 through FIG. 30 is various views of an example of a microfluidics system 700 including the four-connector strip 300 shown in FIG. 6A and FIG. 6B. For example, FIG. 20 through FIG. 23B shows isometric views of an example of a microfluidics system 700 including the four-connector strip 300 shown in FIG. 6A and FIG. 6B. Microfluidics system 700 may be another example of the microfluidics system 100 shown in FIG. 1. More specifically, microfluidics system 700 may include an example of microfluidics device 110 coupled to four-connector strip 300 and wherein four-connector strip 300 may be coupled to and supply one or more sample tubes 190. Further, FIG. 24 and FIG. 25 shows exploded views of microfluidics system 700. Further, FIG. 26 through FIG. 30 shows a front, back, side, top, and bottom view, respectively, of microfluidics system 700.

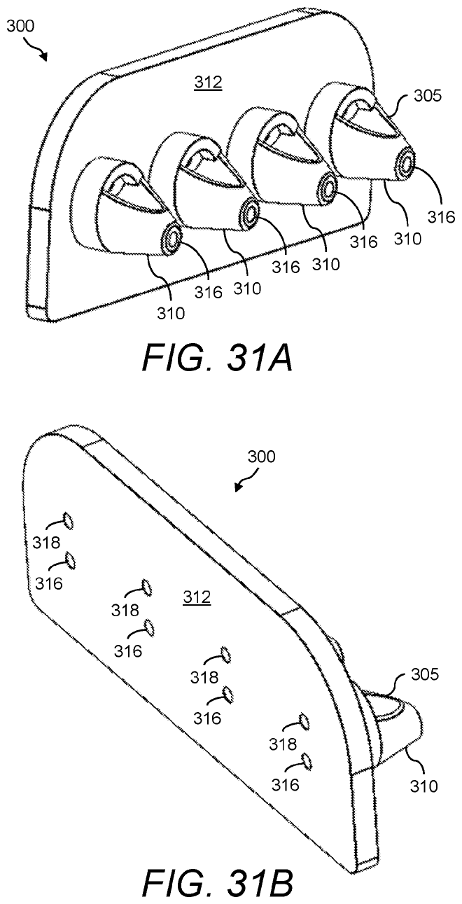

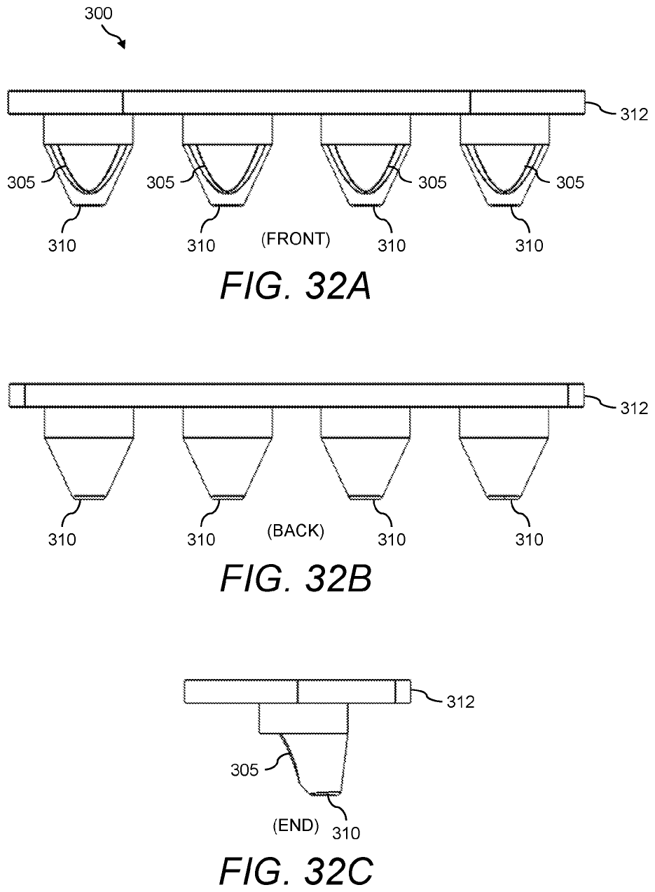

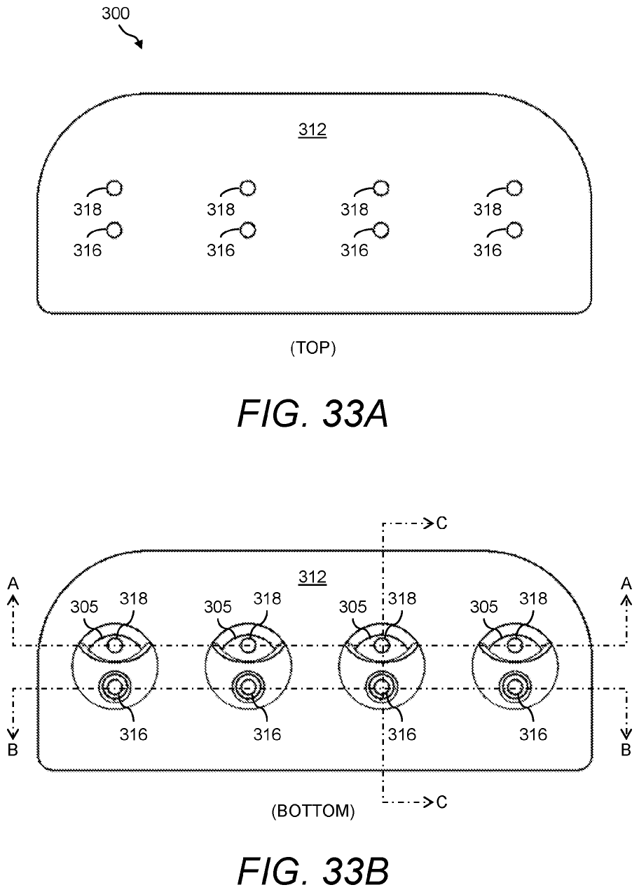

Referring now to FIG. 31A through FIG. 34C is various views of an example of four-connector strip 300 shown in FIG. 6A and FIG. 6B and used in microfluidics system 700 shown in FIG. 20 through FIG. 30. For example, FIG. 31A and FIG. 31B shows isometric views of four-connector strip 300 of microfluidics system 700. Further, FIG. 32A, FIG. 32B, and FIG. 32C shows a front, back, and end view, respectively, of four-connector strip 300 of microfluidics system 700. Further, FIG. 33A and FIG. 33B shows a top and bottom view, respectively, of four-connector strip 300 of microfluidics system 700.

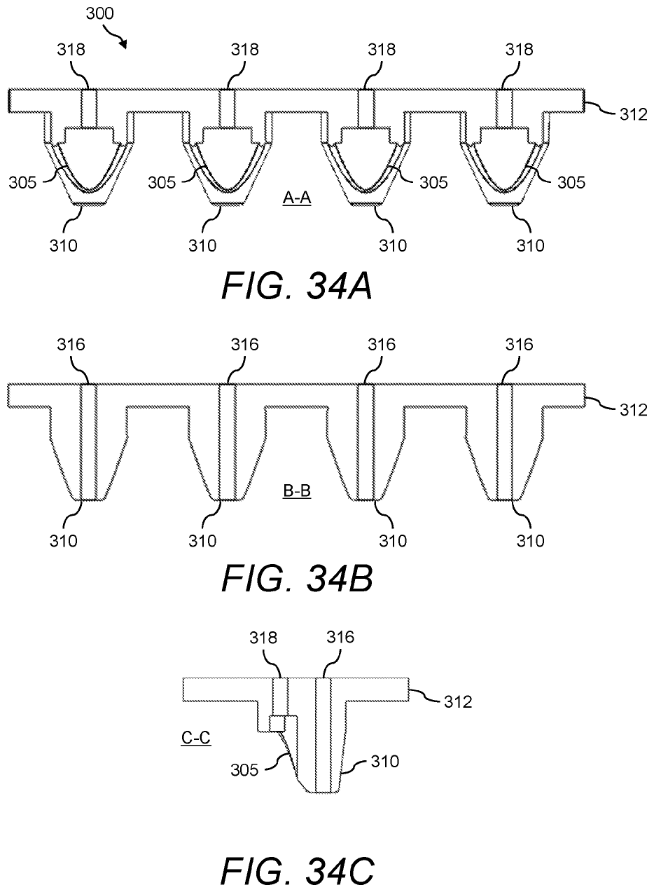

Further, FIG. 34A, FIG. 34B, and FIG. 34C shows cross-sectional views of four-connector strip 300 of microfluidics system 700. For example, FIG. 34A is a cross-sectional view taken along line A-A of FIG. 33B. FIG. 34B is a cross-sectional view taken along line B-B of FIG. 33B. FIG. 34C is a cross-sectional view taken along line C-C of FIG. 33B.

### Methods of Use

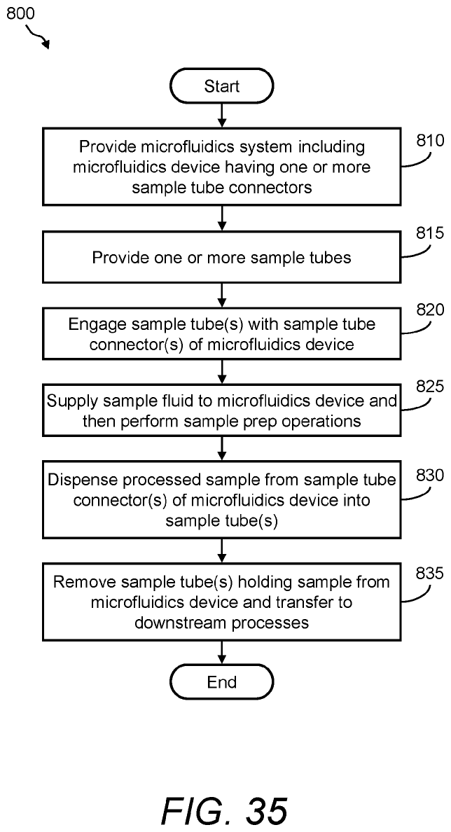

Referring now to FIG. 35 is a flow diagram of an example of a method 800 of using a microfluidics system, such as microfluidics system 100, 500, and 700, including a microfluidics device, such as microfluidics device 110, having one or more of the presently disclosed sample tube connectors, such as, but not limited to, four-connector strips 200, 300, 400 and/or one or more sample tube connectors 630. Method 800 may be an example of a PCR sample prep workflow including flow cell devices and/or DMF devices supplying standard sample tubes without handling (e.g., pipetting). Method 800 may include, but is not limited to, the following steps.

At a step 810, a microfluidics system is provided that includes a microfluidics device having one or more sample tube connectors. For example, microfluidics system 100 is provided that includes microfluidics device 110 having one or more sample tube connectors 130, as shown, for example, in FIG. 1, FIG. 2, and FIG. 3.

At a step 815, one or more sample tubes are provided. For example, one or more standard sample tubes 190 are provided, as shown, for example, in FIG. 2, and FIG. 3. Further, each of the one or more sample tubes 190 may hold some volume (e.g., about 100 μL) of reaction mixture (e.g., PCR master mix) for reacting with the sample liquid.

At a step 820, the sample tube(s) are engaged with the sample tube connector(s) of the microfluidics device. For example, the one or more sample tubes 190 may be engaged with the nozzles of the sample tube connectors 130 of microfluidics device 100. More specifically, the one or more sample tubes 190 may be engaged with nozzles 210 of four-connector strip 200, nozzles 310 of four-connector strip 300, nozzles 410 of four-connector strip 400, or sample tube connectors 630.

At a step 825, sample fluid is supplied to the microfluidics device and then sample prep operations are performed. For example and referring now to FIG. 1, using syringe pump 194 coupled to loading port 118, sample fluid may be supplied to microfluidics device 110 and then sample prep operations may be performed at sample prep region 116 of microfluidics device 110.

At a step 830, the processed sample is dispensed from the sample tube connector(s) of the microfluidics device into the sample tube(s). For example and referring now to FIG. 1, FIG. 2, and FIG. 3, the processed sample may be dispensed from sample tube connectors 130 of microfluidics device 110 into the one or more sample tubes 190. Further to the example, FIG. 9 shows an example of dispensing sample liquid 250 from one nozzle 310 of four-connector strip 300 of microfluidics device 110 into a sample tube 190.

At a step 835, the sample tube(s) holding the sample are removed from the microfluidics device and then capped. Then, the sample tube(s) holding the sample are transferred to any downstream processes. For example, the one or more sample tubes 190 holding the processed sample liquid may be removed from the sample tube connectors 130 of microfluidics device 100. Then the sample tubes 190 may be capped. Then, the sample tubes 190 holding the sample may be transferred to any downstream processes, such as to thermal cycling processes of PCR that are well known, or the sample tubes 190 holding the sample may be stored for later processing.

In summary and referring now again to FIG. 1 through FIG. 35, the presently disclosed sample tube connectors 130 (e.g., four-connector strips 200, 300, 400 and sample tube connector 630) and methods (e.g., method 800) provide a means to interface a microfluidics device (e.g., microfluidics device 110, 500, 700) with a standard sample tube (e.g., sample tube 190). More specifically, the presently disclosed sample tube connectors 130 (e.g., four-connector strips 200, 300, 400 and sample tube connector 630) and methods (e.g., method 800) provide a means of fluidly connecting a microfluidics device (e.g., microfluidics device 110, 500, 700) directly to a standard sample tube (e.g., sample tube 190).

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the invention shall also cover any such alternatives, modifications, variations or equivalents. It is intended that the following claims define the scope of the disclosure and that methods and structures within the scope of these claims and their equivalents be covered thereby.

What is claimed is:

1. A sample tube connector configured to fluidly couple a sample tube to a microfluidics device, the sample tube connector comprising:
one or more nozzles for hermetically attaching a sample tube having one or more shapes, the one or more nozzles comprising:
a flow channel configured to allow a fluid to flow therethrough; and
a vent channel configured to allow air to escape therethrough.

2. The sample tube connector of claim 1, wherein the one or more nozzles are made from a rigid material.

3. The sample tube connector of claim 2, wherein the sample tube connector is formed from a single material.

4. The sample tube connector of claim 1, wherein the one or more nozzles are made from a non-rigid material.

5. The sample tube connector of claim 4, wherein the sample tube connector is formed from one or more materials.

6. The sample tube connector of claim 4, wherein the non-rigid material is elastomer.

7. The sample tube connector of claim 4, wherein the non-rigid material enables the sample tube connector to hermetically attach the sample tube having one or more shapes.

8. The sample tube connector of any one of claims 1-7, wherein the flow channel is positioned substantially off-center within the one or more nozzles to allow a fluid to run down a sidewall of the sample tube.

9. The sample tube connector of any one of claims 1-8, wherein the one or more nozzles is substantially conically shaped.

10. The sample tube connector of any one of claims 1-9, wherein the one or more nozzles is substantially the shape of a pipette tip.

11. The sample tube connector of any one of claims 1-10, wherein the sample tube connector is configured to be attached to one or more components of a microfluidics device.

12. The same tube connector of claim 11, wherein the sample tube connector is either welded or compression fit to the microfluidics device.

13. The sample tube connector of any one of claims 1-12, wherein the one or more nozzles are configured to have the sample tube having one or more shapes press fit or compression fit thereto.

14. The sample tube connector of any one of claims 1-13, wherein the sample tube connector is configured to allow for manipulation of a fluid from a microfluidics device to the sample tube without use of a pipet.

15. A microfluidics devices comprising the sample tube connector of any one of claims 1-14.

16. A method for attaching a sample tube to a microfluidics device, the method comprising the steps of:
providing the sample tube connector of any one of claims 1-14;
attaching the sample tube connector to a component of a microfluidics device; and
attaching a sample tube to the sample tube connector.

17. A method of transferring a sample from a microfluidics device to a sample tube, the method comprising the steps of:
providing the sample tube connector of any one of claims 1-14;
attaching the sample tube connector to a component of a microfluidics device;
attaching a sample tube to the sample tube connector;
manipulating a fluid comprising a sample through at least one channel of the microfluidics device to a point of attachment between the component of the microfluidics device and the sample tube connector; and
manipulating the fluid from the at least one channel to the sample tube through one or more nozzles of the sample tube connector.

18. The method of claim 17, wherein the sample is transferred from the microfluidics device to the sample tube without use of a pipet.
